(19) United States
(12) Patent Application Publication
(10) Pub. No.: US 2010/0315550 A1
(43) Pub. Date: Dec. 16, 2010

(54) IMAGE FRAME INTERPOLATION DEVICE, IMAGE FRAME INTERPOLATION METHOD, AND IMAGE FRAME INTERPOLATION PROGRAM

(76) Inventor: Masayuki YOKOYAMA, Tokyo (JP)

Correspondence Address: FROMMER LAWRENCE & HAUG LLP, 745 FIFTH AVENUE, NEW YORK, NY, 10151, US

(21) Appl. No.: 12/793,763

(22) Filed: Jun. 4, 2010

(30) Foreign Application Priority Data
Jun. 12, 2009 (JP) P2009-140672

(51) Int. Cl. H04N 7/01

(52) U.S. Cl. 348/452; 348/E07.003

(57) ABSTRACT

Disclosed herein is an image frame interpolation device including: a decider configured to decide an interpolation area having a predetermined size for an interpolation frame to be interpolated between adjacent image frames; an acquirer configured to acquire at least two motion vectors between at least one pair of image frames dependent on a position of the interpolation frame based on a position of the interpolation area decided by the decider; a selector configured to apply the at least two motion vectors acquired by the acquirer between two image frames sandwiching the interpolation frame, and select a motion vector to be used based on degrees of correlation between image areas that have a predetermined size and are associated with each other by a respective one of the vectors on the image frames; and a forming unit configured to form and interpolate pixel data by using the vector selected by the selector.

### BACKGROUND OF THE INVENTION

1. Field of the Invention

The present invention relates to device, method, and program for interpolation generation of a frame image at a time position or a viewpoint position that does not exist in e.g. a moving image sequence or a multi-camera system.

2. Description of the Related Art

For a so-called moving image sequence composed of image frames formed in time-series order like one shown in FIG. 12, an image frame that does not originally exist (interpolation frame) is interpolated between the existing frames for e.g. frame rate conversion.

Furthermore, in a multi-camera system like one shown in FIG. 13, an image frame obtained by photographing by a camera (virtual camera) that does not exist between the existing cameras is interpolated for e.g. more multidirectional representation of the image of the object.

In the moving image sequence like that shown in FIG. 12, the respective image frames are processed in the time-series order thereof and have the anteroposterior relationship in terms of time. Thus, numbering (ordering) of each image frame is possible.

As for the images photographed by the multi-camera system like that shown in FIG. 13, numbering (ordering) can be carried out for each of the photographed images (image frames) depending on the positions of the photographing cameras.

In most of the methods for the interpolation generation of an intermediate image frame from two or more image frames configured as shown in FIG. 12 and FIG. 13, initially the corresponding positions (motion vectors) of the respective pixels of the image frames are obtained and then the interpolation pixels are created.

In general, as shown in FIG. 14, the intermediate position on the motion vector from the reference frame (input frame 1) to the scanning basis frame (input frame 2) is defined as the interpolation pixel position, and the pixel on the input image frame (input frame 2) at the position indicated by the motion vector is used as the interpolation pixel.

This method involves a problem of e.g. the existence of the interpolation pixel position through which no motion vector passes (hole) and the existence of the interpolation pixel position through which plural motion vectors pass (overlap). This causes a problem that the amount of processing and the circuit scale are increased for post-processing for these interpolation pixel positions.

To address this problem, a method for obtaining the motion vectors of the respective pixels is disclosed in Japanese Patent Laid-Open No. 2007-181674 (hereinafter, Patent Document 1). In this method, as shown in FIG. 15, the interpolation frame is employed as the scanning basis, and search ranges are provided on the previous and subsequent input image frames, with each interpolation pixel defined as the center. Furthermore, block matching is so carried out that the interpolation pixel is located on the line between both search positions, to thereby obtain the motion vector of each interpolation pixel.

The method disclosed in this Patent Document 1 eliminates the above-described problem of the hole and overlap of the pixel position and makes it possible to rapidly form the image of the interpolation frame through data calculation about the limited range.

However, in the method disclosed in Patent Document 1, although the search range is limited, the search ranges are provided on two input image frames as shown in FIG. 15. This causes a problem that the size of the memory for the search ranges is large.

Furthermore, in the method disclosed in Patent Document 1, the block matching is calculated for each interpolation pixel. This causes a problem that the amount of processing is large if the search range of the block matching is wide and the number of interpolation frames between the input image frames is large.

However, in the case of forming the interpolation frame, a natural interpolation frame may not be formed unless proper motion vectors are acquired in the relationship with the existing frames previous and subsequent to the interpolation frame like in the invention described in Patent Document 1.

Therefore, it is desired that proper motion vectors used for the frame interpolation can be obtained and the interpolation frame can be formed corresponding to the motion vectors rapidly and properly without causing increase in the size of the memory used, increase in the amount of processing, and increase in the processing cost.

### SUMMARY OF THE INVENTION

There is a desire for the present invention to allow motion vectors for forming an interpolation frame to be acquired and utilized rapidly and properly without causing increase in the factors having an influence on the processing cost, such as the number of processing cycles and the power consumption.

According to one embodiment of the present invention, there is provided an image frame interpolation device including decision means for deciding an interpolation area having a predetermined size for an interpolation frame to be interpolated between adjacent image frames, and acquisition means for acquiring at least two motion vectors between at least one pair of image frames dependent on the position of the interpolation frame based on the position of the interpolation area decided by the decision means. The image frame interpolation device further includes selection means for applying these at least two motion vectors acquired by the acquisition means between two image frames sandwiching the interpolation frame, and selecting a motion vector to be used based on the degrees of correlation between image areas that have a predetermined size and are associated with each other by a respective one of the motion vectors on the image frames, and forming means for forming and interpolate pixel data of the interpolation area on the interpolation frame by using the motion vector selected by the selection means.

In the image frame interpolation device according to this embodiment of the present invention, by the decision means, the interpolation area on the interpolation frame to be interpolated between adjacent image frames is decided. Furthermore, by the acquisition means, at least two motion vectors as candidates for the motion vector used in interpolation processing are acquired between at least one pair of image frames dependent on the position of the interpolation frame based on the position of the interpolation area decided by the decision means.

Thereafter, by the selection means, at least two motion vectors acquired by the acquisition means are applied between two image frames sandwiching the interpolation frame. Furthermore, by the selection means, one motion vector actually used in the frame interpolation processing is selected based on the degrees of correlation between image areas that have a predetermined size and are associated with each other by a respective one of the motion vectors on the image frames.

The motion vector selected by the selection means is used and the pixel data of the interpolation area on the interpolation frame is formed by the forming means. Through repetition of the respective kinds of processing by the decision means, the acquisition means, the selection means, and the forming means, the pixel data of the entire interpolation frame are formed. That is, the interpolation frame is formed, so that the interpolation frame is interpolated (added) between the intended image frames.

In this manner, plural motion vectors that will be possibly utilized are acquired for the intended interpolation area decided, and the optimum motion vector is selected from the collection of the motion vectors. By using this motion vector, the interpolation processing (forming processing) for the interpolation frame can be executed.

In the processing until the selection of the motion vector, complex processing is not executed. Furthermore, without causing increase in the processing burden, the motion vector used for forming the interpolation frame can be selected rapidly and properly and utilization thereof can be allowed.

The embodiment of the present invention can acquire the motion vector for forming the interpolation frame rapidly and properly to utilize it without causing increase in the factors having an influence on the processing cost, such as the number of processing cycles and the power consumption.

### BRIEF DESCRIPTION OF THE DRAWINGS

FIG. 1 is a block diagram for explaining a configuration example of a frame interpolator (image frame interpolation device) to which one embodiment of the present invention is applied;

FIG. 2 is a diagram for explaining the outline of processing of acquiring a group of candidates for a motion vector, executed in a motion vector group creator;

FIG. 3 is a diagram for explaining the outline of processing of selecting a motion vector, executed in a motion vector selector;

FIG. 4 is a diagram for explaining the details of the processing of acquiring a group of candidates for a motion vector, executed in the motion vector group creator;

FIG. 5 is a diagram for explaining the details of the processing of selecting a motion vector, executed in the motion vector selector;

FIG. 6 is a flowchart for explaining processing of forming the intended interpolation frame (processing of interpolating a frame), executed in a frame interpolator;

FIG. 7 is a flowchart for explaining processing of acquiring a collection of motion vectors, executed in a step S2 of FIG. 6;

FIG. 8 is a flowchart for explaining processing of selecting one motion vector used in interpolation processing from a collection of motion vectors, executed in a step S3 of FIG. 6;

FIG. 9 is a diagram for explaining one example of the case in which plural motion vectors are acquired between each of plural pairs of frames;

FIG. 10 is a diagram for explaining one example of the combination of frames from which the motion vector is obtained;

FIG. 11 is a block diagram for explaining a frame interpolator of modification example 2;

FIG. 12 is a diagram for explaining one example of frame interpolation;

FIG. 13 is a diagram for explaining one example of frame interpolation;

FIG. 14 is a diagram for explaining one example of the related-art pixel interpolation processing for frame interpolation; and

FIG. 15 is a diagram for explaining another example of the related-art pixel interpolation processing for frame interpolation.

### DETAILED DESCRIPTION OF THE PREFERRED EMBODIMENT

Device, method, and program according to one embodiment of the present invention will be described below with reference to the drawings.

### [Configuration Example of Frame Interpolator]

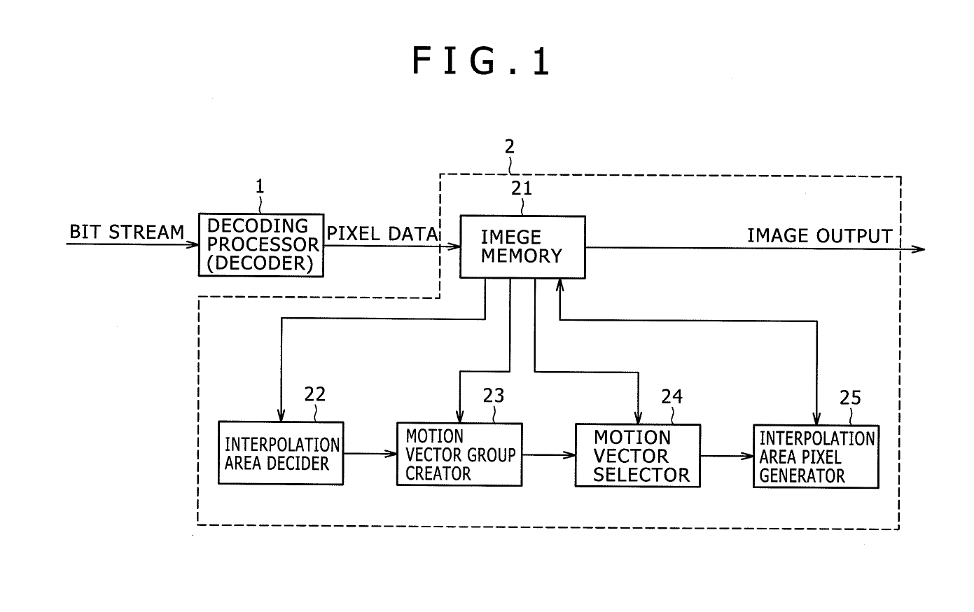

FIG. 1 is a block diagram for explaining a configuration example of a frame interpolator (image frame interpolation device) configured by applying the device, method, and program according to one embodiment of the present invention. In FIG. 1, a frame interpolator 2 is the part to which the embodiment of the present invention is applied.

A decoding processor 1 executes decoding processing for moving image data coded by a predetermined moving image coding system to restore the original moving image data before the coding. The decoding processor 1 supplies this restored moving image data (pixel data in units of the frame) to the frame interpolator 2.

Examples of the moving image coding system include various systems such as the MPEG-2 (Moving Picture Experts Group phase 2), the MPEG-4 (Moving Picture Experts Group phase 4), and the H.264 (MPEG-4 Advanced Video Coding). In this embodiment, the decoding processor 1 can execute the decoding processing conforming to e.g. the H.264.

Specifically, the decoding processor 1 executes e.g. entropy decoding processing, inverse zigzag transform, inverse quantization, inverse orthogonal transform (including overlap smoothing filter), and intra prediction (including AC/DC prediction). Furthermore, the decoding processor 1 also executes motion vector prediction, motion compensation (including weighted prediction, range reduction, and intensity compensation), deblocking filter, and so on.

As shown in FIG. 1, the frame interpolator 2 includes an image memory 21, an interpolation area decider 22, a motion vector group creator 23, a motion vector selector 24, and an interpolation area pixel generator 25.

The image memory 21 has such memory capacity that the pixel data of plural frames can be accumulated therein. Specifically, the image memory 21 can store and hold the pixel data of at least two adjacent frames used for forming an interpolation frame and can also store and hold the pixel data of the interpolation frame to be formed.

Furthermore, the memory capacity of the image memory 21 also has room that allows the image memory 21 to temporarily store completely all of decoded pixel data supplied thereto during the forming of the pixel data of one interpolation frame.

As above, the image memory 21 has such memory capacity as to be capable of storing and holding the pixel data of the plural frames used for forming an interpolation frame, the pixel data of the interpolation frame to be formed by the interpolation, and the pixel data supplied from the decoding processor 1 during the interpolation processing.

The interpolation area decider 22 has functions as the decider for deciding the interpolation area that has a predetermined size and is treated as the interpolation object in the interpolation frame to be formed by the interpolation. The minimum size of the interpolation area is the size of one pixel, and it is also possible to employ an area (processing block) composed of plural pixels as the interpolation area depending on the processing capability of the frame interpolator 2.

Specifically, as the interpolation area, e.g. a processing block having the same size as that of the macroblock composed of 16 pixels×16 pixels can be employed. In addition, it is also possible to employ any of processing blocks having various sizes, such as 8 pixels×8 pixels, 4 pixels×4 pixels, and 8 pixels×4 pixels.

Furthermore, in this embodiment, the interpolation area decider 22 sequentially decides the interpolation area in such a manner as to move the interpolation area in the horizontal direction from the upper left end as the origin in the interpolation frame without overlapping between the current and previous interpolation areas. Upon the arrival of the interpolation area at the right end of the interpolation frame, the interpolation area decider 22 executes the processing for the lower interpolation area row from the left end of the interpolation frame.

For example, when the size of the interpolation area is equal to the size of one pixel, the interpolation area row is a row that has the width of one pixel as its vertical width and has the width of one frame in the horizontal direction. When the size of the interpolation area is equivalent to the macroblock composed of 16 pixels×16 pixels, the interpolation area row is a row that has the width of 16 pixels as its vertical width and has the width of one frame in the horizontal direction.

As above, the interpolation area decider 22 sequentially decides the interpolation area having a predetermined size in such a manner as to move the interpolation area in order decided in advance on the interpolation frame to be formed by the interpolation, and the interpolation area decider 22 notifies the motion vector group creator 23 of which position on the interpolation frame the interpolation area is set at.

The motion vector group creator 23 has functions as the acquirer for acquiring a group of candidates for the motion vector used in the interpolation processing (collection of motion vectors), for interpolating the pixel in the interpolation area decided by the interpolation area decider 22.

Specifically, the motion vector group creator 23 acquires at least two motion vectors between at least one pair of image frames dependent on the position of the interpolation frame to be created by the interpolation, based on the position of the interpolation area decided by the interpolation area decider 22.

As also described in detail later, the motion vector group creator 23 regards an image frame at an anterior position in terms of time as the reference frame and regards an image frame at a posterior position in terms of time as the scanning basis frame in at least one pair of image frames from which the motion vectors are obtained.

Furthermore, the motion vector group creator 23 obtains the motion vector to the scanning basis frame about an image area having a predetermined size on the reference frame at one or more positions corresponding to the interpolation area decided on the interpolation frame by the interpolation area decider 22. The image area having the predetermined size on the reference frame, about which the motion vector is obtained, is e.g. the macroblock composed of 16 pixels×16 pixels or a block having another size.

More specifically, if two or more pairs of image frames between which the motion vector is obtained are set, the motion vector group creator 23 obtains at least one motion vector between each of the pairs of image frames.

If one pair of image frames between which the motion vector is obtained is set, the motion vector group creator 23 obtains at least two motion vectors between this pair of image frames. In this manner, the motion vector group creator 23 creates a group of candidates for the motion vector used in the interpolation processing.

The motion vector selector 24 has functions as the selector for selecting one motion vector used in the interpolation of the pixel of the interpolation area decided by the interpolation area decider 22 from the plural motion vector candidates created (acquired) by the motion vector group creator 23.

Specifically, the motion vector selector 24 applies the plural motion vectors acquired by the motion vector group creator 23 between the frames that are adjacent to the interpolation frame to be interpolated this time and sandwich this interpolation frame in such a way that the motion vectors each pass through the interpolation area on the interpolation frame.

Furthermore, for each of the plural motion vectors applied, the motion vector selector 24 obtains the degree of correlation between the corresponding image areas associated with each other by the motion vector on both image frames. Based on the degrees of correlation, the motion vector selector 24 selects one motion vector to be used.

In this embodiment, the degree of correlation between the corresponding image areas associated with each other by the motion vector on both image frames is grasped by using e.g. the sum of absolute differences as also described later.

The interpolation area pixel generator 25 has functions as the forming unit for generating (forming) the pixel data of the interpolation area as the current interpolation object by using the motion vector selected by the motion vector selector 24.

Specifically, the interpolation area pixel generator 25 generates the pixel data of the interpolation area as the current interpolation object by using the motion vector selected by the motion vector selector 24 and one or both of the image frames previous and subsequent to the interpolation frame to be formed by the interpolation.

The pixel data of the interpolation area on the interpolation frame, generated by the interpolation area pixel generator 25, is stored in the storage area for the pixel data to form the interpolation frame in the image memory 21. The pixel data of the interpolation frame formed by the interpolation area pixel generator 25 is read out from the image memory 21 and allowed to be utilized as pixel data to form a frame image similarly to the pixel data of other image frames.

As above, in the frame interpolator 2 of this embodiment, the interpolation area decider 22, the motion vector group creator 23, the motion vector selector 24, and the interpolation area pixel generator 25 work in cooperation with each other and thereby can properly select the motion vector used in the interpolation processing for each interpolation area.

Furthermore, the frame interpolator 2 of this embodiment executes the interpolation processing for the decided interpolation area by using the selected motion vector and thereby can properly generate the individual pixel data to form the interpolation frame. That is, it can properly form the image of the intended interpolation frame.

### [Outline of Operation of Frame Interpolator 2]

A specific description will be made below about the frame interpolation processing executed in the frame interpolator 2 of this embodiment shown in FIG. 1.

As also described above, the interpolation area decider 22 in the frame interpolator 2 of this embodiment sequentially decides the interpolation area having a predetermined size in such a manner as to move the interpolation area in order decided in advance on the interpolation frame to be formed by the interpolation.

Furthermore, the motion vector group creator 23 in the frame interpolator 2 of this embodiment acquires the motion vector between the input frames immediately previous to the intended interpolation frame and between the image frames that are adjacent to the interpolation frame and sandwich the interpolation frame.

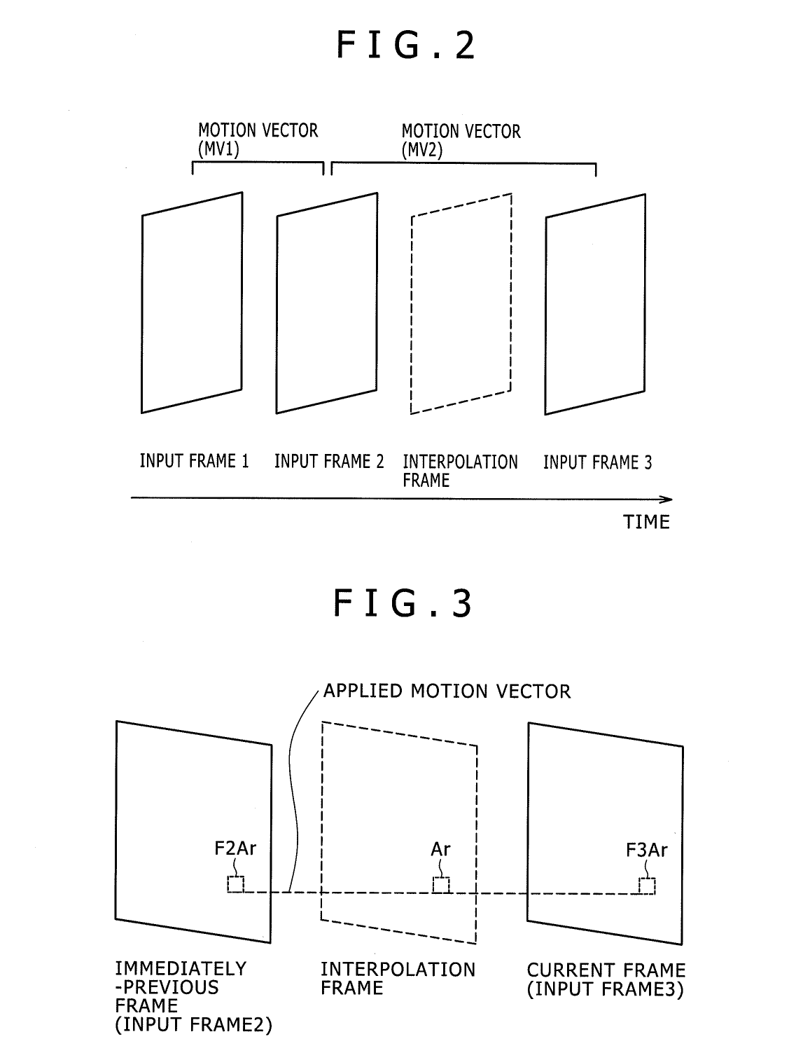

FIG. 2 is a diagram for explaining the outline of the processing of acquiring a group of candidates for the motion vector, executed in the motion vector group creator 23.

Here, suppose that the pixel data in units of the frame arising from decoding processing in the decoding processor 1 are supplied from the decoding processor 1 to the image memory 21 in order of input frame 1, input frame 2, and input frame 3 as shown in FIG. 2 and are temporarily stored in the image memory 21.

In this case, because the time-forward direction is the right direction as shown by the arrowhead in FIG. 2, input frame 1 is the oldest frame and input frame 3 is the latest frame in FIG. 2. Furthermore, suppose that an interpolation frame is to be formed between input frame 2 and input frame 2 as shown by the dotted line in FIG. 2.

In this case, as shown in FIG. 2, initially the motion vector group creator 23 creates and acquires a first motion vector (MV1) between the image frames immediately previous to the interpolation frame, i.e. between input frame 1 and input frame 2.

Subsequently, as shown in FIG. 2, the motion vector group creator 23 creates and acquires a second motion vector (MV2) between the image frames that are adjacent to the interpolation frame and sandwich the interpolation frame, i.e. between input frame 2 and input frame 3.

As described in detail later, in the creation and acquisition of plural motion vectors as candidates for the motion vector used in the interpolation processing, the motion vectors are obtained based on the position of the interpolation area decided by the interpolation area decider 22.

Subsequently, the motion vector selector 24 selects one motion vector used for generation of the image of the interpolation area from the first motion vector (MV1) and the second motion vector (MV2) created and acquired by the motion vector group creator 23.

FIG. 3 is a diagram for explaining the outline of the processing of selecting the motion vector, executed in the motion vector selector 24. The motion vector selector 24 applies each of the motion vectors belonging to the candidates for the motion vector used in the interpolation processing, created in the motion vector group creator 22, between the frames that are adjacent to the interpolation frame and sandwich the interpolation frame.

In the case of the example shown in FIG. 2, as shown in FIG. 3, the first and second motion vectors acquired by the motion vector group creator 23 are applied between input frame 2 and input frame 3, which sandwich the interpolation frame indicated by the dotted line. In the application of the motion vectors, the interpolation area Ar decided by the interpolation area decider 22 is used as the basis.

In FIG. 3, the area Ar shown on the interpolation frame indicates the interpolation area decided by the interpolation area decider 22 shown in FIG. 1. Furthermore, an image area F2Ar on input frame 2 and an image area F3Ar on input frame 3 indicate the image areas that have a predetermined size and are associated with each other by the applied motion vector on the respective input frames.

The motion vector selector 24 obtains the degree of correlation between the image area F2Ar and the image area F3Ar, which are associated with each other by the applied motion vector and are on input frame 2 as the frame immediately previous to the interpolation frame and on input frame 3 as the frame immediately subsequent to the interpolation frame, respectively.

In this manner, about each of the motion vectors acquired as the candidates for the motion vector to be used, the degree of correlation between the corresponding image areas on the frames previous and subsequent to the interpolation frame is obtained. Subsequently, the motion vector selector 24 selects the motion vector with which the highest degree of correlation is obtained as the motion vector used in the processing of interpolating the pixel in the interpolation area.

In this embodiment, the degree of correlation between the image areas that have a predetermined size and are associated with each other by the motion vector on the frames previous and subsequent to the interpolation frame is determined by using the sum of absolute differences as also described above. Hereinafter, the sum of absolute differences is abbreviated as “SAD.”

### [Details of Processing of Acquiring Group of Candidates for Motion Vector and Processing of Selecting Motion Vector]

A more detailed description will be made below about the processing of acquiring a group of candidates for the motion vector used for the interpolation and the processing of selecting the motion vector used for the interpolation from the group of the acquired candidates for the motion vector.

### [Details of Processing of Acquiring Group of Candidates for Motion Vector]

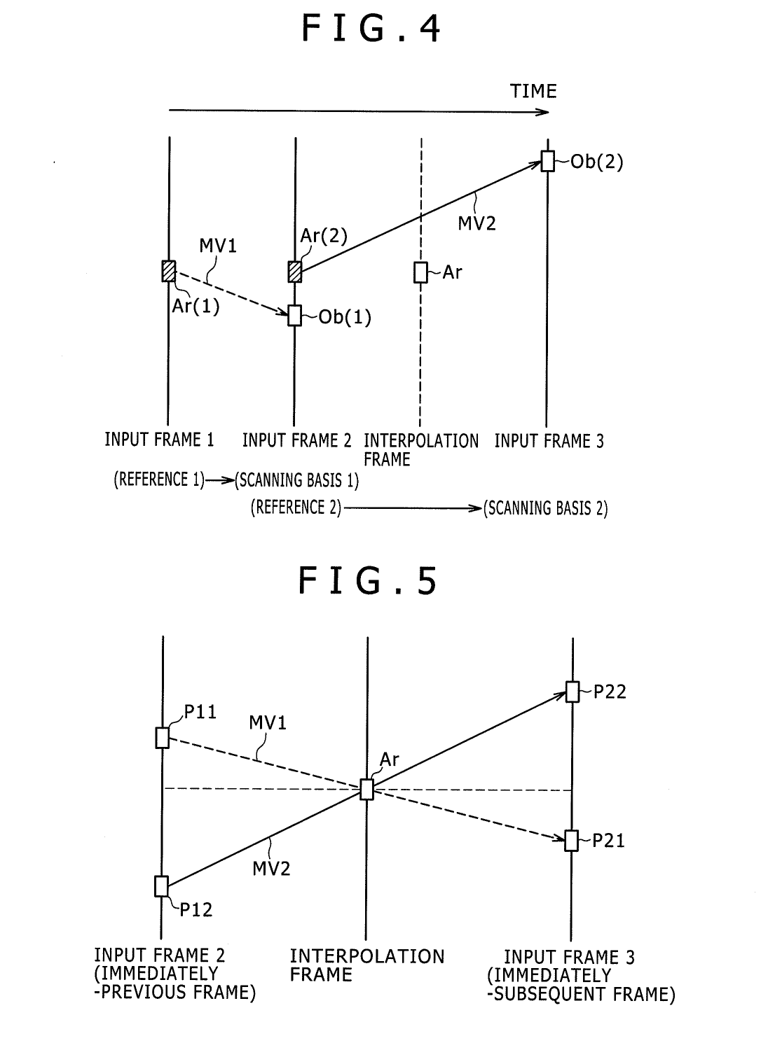

Initially, a detailed description will be made below about the processing of acquiring a group of candidates for the motion vector, executed in the motion vector group creator 23 of this embodiment. FIG. 4 is a diagram for explaining the details of the processing of creating and acquiring a group of candidates for the motion vector, executed in the motion vector group creator 23 of this embodiment.

FIG. 4 conceptually shows image frames captured in the image memory 21, when viewed edge-on. FIG. 4 shows the case in which input frame 1, input frame 2, and input frame 3 are temporarily stored in the image memory 21 and an interpolation frame is to be formed between input frame 2 and input frame 3 similarly to the case described with use of FIG. 2.

This example is based on the assumption that an interpolation area Ar is decided on the interpolation frame indicated by the dotted line by the interpolation area decider 22 as shown in FIG. 4. Furthermore, this example is based on the assumption that the interpolation area Ar has e.g. a size of 16 pixels×16 pixels similarly to the macroblock.

As described above with use of FIG. 2, the motion vector group creator 23 obtains the first motion vector (MV1) between input frame 1 and input frame 2, which are the pair of image frames immediately previous to the interpolation frame.

In this case, the motion vector group creator 23 sets, on input frame 1, an image area Ar(1) for obtaining the first motion vector (MV1) at the same position as that of the interpolation area Ar decided on the interpolation frame. In this embodiment, the image area Ar(1) has e.g. the same size as that of the macroblock composed of 16 pixels×16 pixels.

Subsequently, the motion vector group creator 23 scans input frame 2 as the scanning basis frame and detects the image area on input frame 2 corresponding to the image area Ar(1) on input frame 1. In this case, the scanning range on input frame 2 may be selected depending on e.g. the position of the interpolation area on the interpolation frame.

Thereby, as shown in FIG. 4, the first motion vector (MV1) from the image area Ar(1) on input frame 1 to the corresponding image area Ob(1) on input frame 2 is obtained.

As above, the motion vector from the image area Ar(1) at the same position on input frame 1 as that of the decided interpolation area Ar on the interpolation frame to the corresponding image area Ob(1) on input frame 2 is the intended first motion vector (MV1).

Next, the motion vector group creator 23 obtains the second motion vector (MV2) between input frame 2 and input frame 3, which are adjacent to the interpolation frame and sandwich the interpolation frame.

In this case, as shown in FIG. 4, the motion vector group creator 23 sets, on input frame 2, an image area Ar(2) for obtaining the second motion vector (MV2) at the same position as that of the interpolation area Ar decided on the interpolation frame. In this embodiment, the image area Ar(2) also has e.g. the same size as that of the macroblock composed of 16 pixels×16 pixels.

Subsequently, the motion vector group creator 23 scans input frame 3 as the scanning basis frame and detects the image area on input frame 3 corresponding to the image area Ar(2) on input frame 2. Also in this case, the scanning range on input frame 3 may be selected depending on e.g. the position of the interpolation area on the interpolation frame similarly to the obtaining of the first motion vector (MV1).

Thereby, as shown in FIG. 4, the second motion vector (MV2) from the image area Ar(2) on input frame 2 to the corresponding image area Ob(2) on input frame 3 is obtained.

As above, the motion vector from the image area Ar(2) at the same position on input frame 2 as that of the decided interpolation area Ar on the interpolation frame to the corresponding image area Ob(2) on input frame 3 is the intended second motion vector (MV2).

In the above-described manner, the motion vector group creator 23 acquires each one candidate for the motion vector used in the interpolation processing between the frames immediately previous to the interpolation frame and between the frames that are adjacent to the interpolation frame and sandwich the interpolation frame.

### [Details of Processing of Selecting Motion Vector]

Next, a detailed description will be made below about the processing of selecting the motion vector, executed in the motion vector selector 24 of this embodiment. FIG. 5 is a diagram for explaining the details of the processing of selecting the motion vector, executed in the motion vector selector 24 of this embodiment.

The motion vector selector 24 applies the first motion vector (MV1) and the second motion vector (MV2) created by the motion vector group creator 23 as described with use of FIG. 4 between the frames that are adjacent to the interpolation frame and sandwich the interpolation frame.

In this example, the frames that are adjacent to the interpolation frame and sandwich the interpolation frame are input frame 2 immediately previous to the interpolation frame and input frame 3 immediately subsequent to the interpolation frame as shown in FIG. 4 and FIG. 5.

In the application of the first motion vector (MV1) and the second motion vector (MV2), the interpolation area Ar on the interpolation frame, decided by the interpolation area decider 22, is employed as the basis.

That is, the first motion vector (MV1) and the second motion vector (MV2) are applied between input frame 2 and input frame 3. In this case, both motion vectors are so applied as to pass through the same position (pixel) in the interpolation area Ar on the interpolation frame as shown in FIG. 5.

Thereafter, as shown in FIG. 5, the value of correlation between an image area P11 on input frame 2 and an image area P21 on input frame 3, which are associated with each other by the first motion vector (MV1), is obtained.

Similarly, as shown in FIG. 5, the value of correlation between an image area P12 on input frame 2 and an image area P22 on input frame 3, which are associated with each other by the second motion vector (MV2), is obtained.

As described above, in the acquisition of the motion vector, the motion vector is obtained about the image area having the same size as that of the macroblock. Thus, in this embodiment, all of the image areas P11 and P12 on input frame 2 and the image areas P21 and P22 on input frame 3 have the same size as that of the macroblock.

Furthermore, in this embodiment, the SAD (sum of absolute differences) is used as the value of correlation between the image areas associated with each other by the first and second motion vectors. The SAD is obtained as follows. Specifically, about two corresponding image areas, the values of difference in the pixel value between the corresponding pixels are obtained and the absolute values of these values of difference are obtained. Furthermore, the sum of these absolute values is obtained.

As above, the SAD is the value achieved by, about the corresponding image areas on two frames, obtaining the absolute values of the differences between the pixels at the corresponding positions and taking the sum of these absolute values. Therefore, the SAD is “0” if the pixel values possessed by the pixels included in two corresponding image areas are exactly identical to each other between two frames. Thus, a pair of image areas from which a smaller SAD is obtained can be regarded as having higher degree of correlation therebetween.

Therefore, as shown in FIG. 5, the motion vector selector 24 obtains the SAD (first SAD) between the image area P11 on input frame 2 and the image area P21 on input frame 3, which are associated with each other by the first motion vector (MV1).

Furthermore, as shown in FIG. 5, the motion vector selector 24 obtains the SAD (second SAD) between the image area P12 on input frame 2 and the image area P22 on input frame 3, which are associated with each other by the second motion vector (MV2).

Subsequently, the motion vector selector 24 compares the obtained first SAD and second SAD, and selects the motion vector associating the image areas having the smaller SAD as the motion vector actually used in the interpolation processing for the interpolation area.

For example, if the first SAD is smaller than the second SAD, the first motion vector (MV1) is selected as the motion vector used for the interpolation. In contrast, if the second SAD is smaller than the first SAD, the second motion vector (MV2) is selected as the motion vector used for the interpolation.

As above, the motion vector selector 24 of this embodiment selects the motion vector that is more suitable to be used for the interpolation from the first motion vector and the second motion vector created by the motion vector group creator 23.

### [Processing of Generating Pixel Data of Interpolation Area]

Thereafter, the interpolation area pixel generator 25 uses the motion vector selected by the motion vector selector 24 to generate the pixel data of the interpolation area on the interpolation frame by using the pixel data of one or both of the previous and subsequent frames associated with each other by this motion vector.

The interpolation area pixel generator 25 may create the pixel data of the interpolation area by using e.g. the pixel data loaded from the corresponding image area on the corresponding frame in the image memory 21 for the SAD calculation by the motion vector selector 24.

In this case, such a configuration is possible that the pixel data loaded by the motion vector selector 24 for the SAD calculation is temporarily stored in e.g. a predetermined buffer and the interpolation area pixel generator 25 can also refer to the pixel data.

This eliminates the need for the interpolation area pixel generator 25 to load the pixel data of the intended image part on the intended frame from the image memory 21. Consequently, the processing burden can be reduced because there is no need to load the intended pixel data from the image memory 21 by carrying out somewhat complex address control.

Furthermore, for the generation of the pixel data of the interpolation area, it is possible to use any of various interpolation processing methods such as a method in which the pixel data of either of the corresponding pixel areas on the previous and subsequent frames is selected and used and a method in which the average of the pixel data of the corresponding pixel areas on the previous and subsequent frames is taken.

### [Summarization of Operation of Frame Interpolator 2]

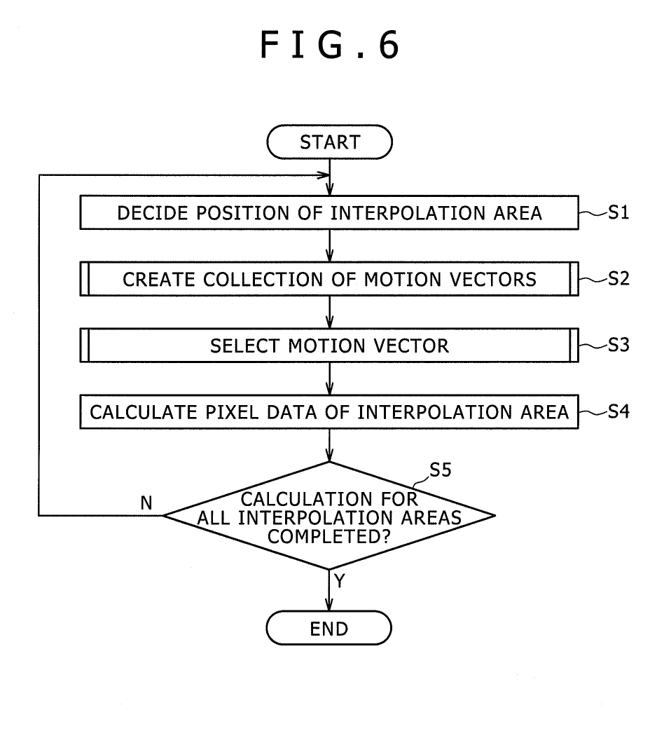

Next, the operation of the frame interpolator 2 of this embodiment will be summarized below with reference to flowcharts of FIGS. 6 to 8. FIG. 6 is the flowchart for explaining the processing of forming the intended interpolation frame (processing of interpolating a frame), executed in the frame interpolator 2.

The processing shown in FIG. 6 is executed in the frame interpolator 2 when image data arising from decoding by the decoding processor 1 are supplied to the image memory 21 and temporarily stored therein to accumulate the pixel data of a predetermined number of frames and an interpolation frame is to be formed at a predetermined position.

Regarding the predetermined position at which the interpolation frame is to be formed, various modes will be possible depending on the purpose, such as a mode in which the interpolation frame is formed between each pair of input frames, a mode in which the interpolation frame is formed as every third frame, and a mode in which the interpolation frame is formed as every fourth frame.

Upon the decision of the forming of the interpolation frame at the predetermined position, initially the interpolation area decider 22 in the frame interpolator 2 decides the position of the interpolation area having a predetermined size, in which the interpolation pixel is to be formed, on this interpolation frame (step S1).

In this case, the interpolation area decider 22 sequentially decides the interpolation area in such a manner as to move the interpolation area in the horizontal direction from the upper left end as the origin in the interpolation frame without overlapping between the current and previous interpolation areas, as also described above. Upon the arrival of the interpolation area at the right end of the interpolation frame, the interpolation area decider 22 sequentially decides the interpolation area similarly on the lower interpolation area row.

In this manner, on the interpolation frame to be formed by the interpolation, the interpolation area decider 22 decides the interpolation area in which pixel data is to be actually formed by the interpolation in such a way that the interpolation area is sequentially moved in order decided in advance and the whole of the interpolation frame is covered.

Upon the decision of the interpolation area on the interpolation frame by the interpolation area decider 22, the motion vector group creator 23 creates a group of candidates for the motion vector used for the interpolation (collection of motion vectors) in consideration of the position of the interpolation frame and the position of the decided interpolation area (step S2).

Thereafter, the motion vector selector 24 selects one motion vector actually used in the interpolation processing from the group of candidates for the motion vector used in the interpolation processing (collection of motion vectors), created by the motion vector group creator 23 in the step S2 (step S3).

Subsequently, the interpolation area pixel generator 25 uses the motion vector selected by the motion vector selector 24 in the step S3 to generate (calculate) the pixel data of the interpolation area on the interpolation frame, decided in the step S1 as described above (step S4). The pixel data formed in this step S4 is written to the recording area for the pixel data of the interpolation frame in the image memory 21 so that they can be utilized as also described above.

Thereafter, for example, the interpolation area pixel generator 25 determines whether or not the pixel data have been generated for all of the interpolation areas on the intended interpolation frame, i.e. whether or not the generation of all of the pixel data to form the intended interpolation frame has been completed (step S5).

If it is determined in the determination processing of the step S5 that the generation of all of the pixel data to form the intended interpolation frame has not been completed, the processing from the step S1 is repeated.

That is, the series of processing including the following steps is repeated: the next interpolation area on the interpolation frame is decided (step S1); a group of candidates for the motion vector is created about this interpolation area (step S2); the motion vector used in the interpolation processing is selected from the group of candidates for the motion vector (step S3); and the pixel data of the interpolation area is generated by using the selected motion vector (step S4).

In this manner, by the functions of the frame interpolator 2, the interpolation frames can be supplemented at the intended potentials in moving image data, so that the intended moving image data can be formed.

### [Processing of Creating Collection of Motion Vectors]

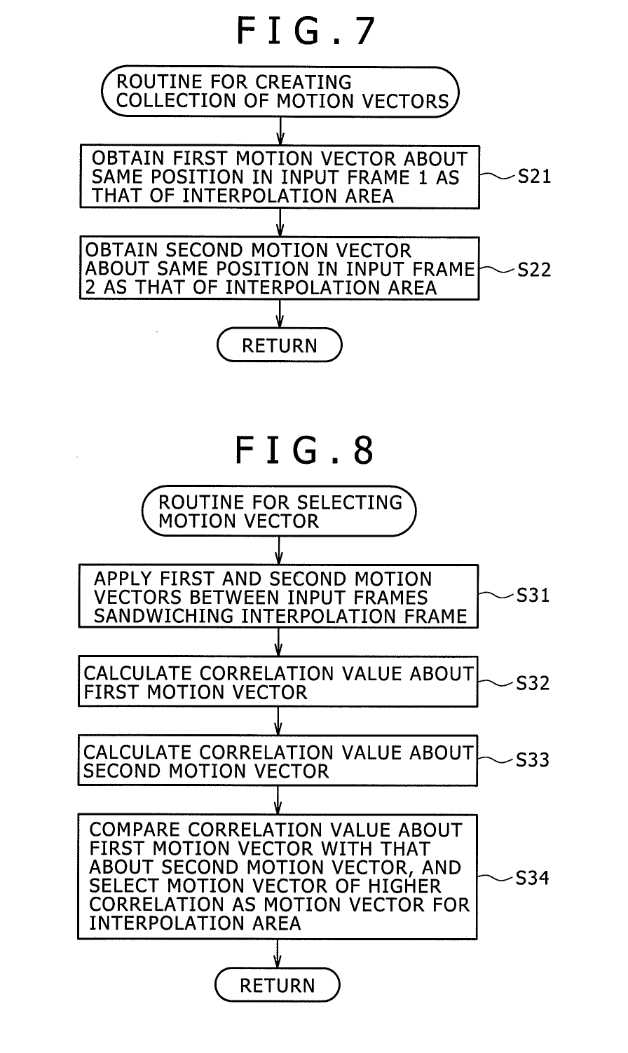

Next, a description will be made below about the processing of creating a group of candidates for the motion vector used in the interpolation processing, i.e. the processing of creating a collection of motion vectors, executed in the step S2 of FIG. 6. FIG. 7 is the flowchart for explaining the processing of creating a collection of motion vectors, executed in the step S2 of FIG. 6.

As also described above, the motion vector group creator 23 in the frame interpolator 2 of this embodiment creates each one candidate for the motion vector between the input frames immediately previous to the interpolation frame and between the frames that are adjacent to the interpolation frame and sandwich the interpolation frame.

For this purpose, as described with use of FIG. 2 and FIG. 4, initially the motion vector group creator 23 obtains the first motion vector (MV1) about the same position in input frame 1 as that of the interpolation area (step S21).

Specifically, in the step S21, input frame 2 is employed as the scanning basis frame, and the motion vector to input frame 2 about the image area at the same position on input frame 1 as that of the interpolation area is obtained as the first motion vector (MV1) as also described above.

Subsequently, as described with use of FIG. 2 and FIG. 4, the motion vector group creator 23 obtains the second motion vector (MV2) about the same position in input frame 2 as that of the interpolation area (step S22).

Specifically, in the step S22, input frame 3 is employed as the scanning basis frame, and the motion vector to input frame 3 about the image area at the same position on input frame 2 as that of the interpolation area is obtained as the second motion vector (MV2) as also described above.

In this manner, in the motion vector group creator 23 of this embodiment, the motion vector about the image area corresponding to the position of the interpolation area decided by the interpolation area decider 22 is obtained between each of two pairs of input frames dependent on the position of the interpolation frame.

### [Processing of Selecting Motion Vector]

Next, a description will be made below about the processing of selecting one motion vector used in the interpolation processing from the created collection of motion vectors, executed in the step S3 of FIG. 6. FIG. 8 is the flowchart for explaining the processing of selecting one motion vector used in the interpolation processing from the collection of motion vectors, executed in the step S3 of FIG. 6.

Initially, the motion vector selector 24 applies the plural motion vectors created by the processing of the step S2 of FIG. 6 between the frames that are adjacent to the interpolation frame and sandwich the interpolation frame (step S31).

In the case of the above-described example, the first and second motion vectors are applied between input frame 2 and input frame 3, which sandwich the interpolation frame. In this case, both motion vectors are so applied as to pass through the same position in the interpolation area on the interpolation frame.

The motion vector selector 24 obtains the first SAD (sum of absolute differences) as the value of correlation between the image areas associated with each other by the first motion vector applied between input frame 2 and input frame 3 (step S32).

Similarly, the motion vector selector 24 obtains the second SAD (sum of absolute differences) as the value of correlation between the image areas associated with each other by the second motion vector applied between input frame 2 and input frame 3 (step S33).

Subsequently, the motion vector selector 24 compares the first SAD (first correlation value) obtained in the step S32 with the second SAD (second correlation value) obtained in the step S33, and selects the motion vector from which higher correlation is obtained as the motion vector used for the interpolation (step S34).

In the step S34, it can be determined that the degree of correlation between the image areas associated with each other by the motion vector is higher when the value of the SAD between these image areas is smaller as also described above. Thus, the motion vector from which the smaller one of the first and second SADs is obtained is selected as the motion vector used for the interpolation.

As above, in the motion vector selector 24 of this embodiment, the plural motion vectors created by the motion vector group creator 23 are applied between the input frames sandwiching the interpolation frame.

Furthermore, the optimum motion vector for use in the interpolation processing can be selected depending on the degrees of correlation between the image areas associated with each other by a respective one of the plural motion vectors, in the respective applied frames.

### ADVANTAGEOUS EFFECTS OF EMBODIMENT

As described above, a group of candidates for the motion vector is created between plural frames depending on the position of the interpolation frame and the position of the interpolation area decided on the interpolation frame, and the optimum motion vector for use in the interpolation processing is selected from the group to thereby allow the interpolation processing.

Therefore, differently from the related art in which the interpolation frame is formed, the motion vector does not need to be calculated by block matching or the like for each interpolation frame. Thus, for the case in which the search range for seeking the motion vector is wide and the number of interpolation frames is large, the amount of processing for calculating the motion vector for the interpolation frame can be reduced compared with the related-art method.

Consequently, the interpolation frame can be formed rapidly and properly and use thereof can be allowed. Thus, by using the embodiment of the present invention for various cases in which a frame that does not exist needs to be supplemented in an image in units of existing frames, such as the case of rate conversion of moving image data, the interpolation frame can be formed and inserted at the intended image position rapidly and properly.

### Modification Example 1

In the above-described embodiment, each one motion vector is acquired between the input frames immediately previous to the interpolation frame and between the input frames that are adjacent to the interpolation frame and sandwich the interpolation frame, depending on the position of the interpolation area set on the interpolation frame.

However, the way of the motion vector acquisition is not limited thereto. For example, plural motion vectors may be acquired between the input frames immediately previous to the interpolation frame (in the case of the above-described example, between input frame 1 and input frame 2), and one motion vector may be selected from these acquired motion vectors.

Alternatively, plural motion vectors may be acquired between the input frames that are adjacent to the interpolation frame and sandwich the interpolation frame (in the case of the above-described example, between input frame 2 and input frame 3), and one motion vector may be selected from these acquired motion vectors.

More alternatively, each one plurality of motion vectors may be acquired between the input frames immediately previous to the interpolation frame and between the input frames that are adjacent to the interpolation frame and sandwich the interpolation frame, depending on the position of the interpolation area set on the interpolation frame.

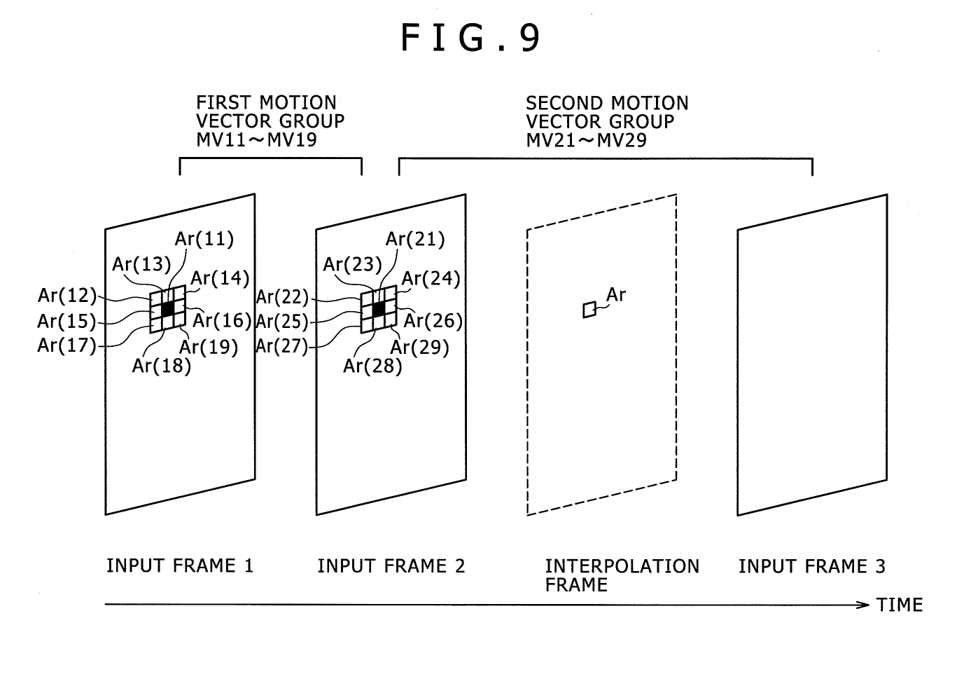

FIG. 9 is a diagram for explaining one example of the case in which plural motion vectors are acquired between each of plural pairs of input frames. Also in the example shown in FIG. 9, input frame 1, input frame 2, and input frame 3 are stored similarly to the embodiment described with use of FIG. 2 and FIG. 4.

The example shown in FIG. 9 is also based on the assumption that an interpolation frame is to be formed between input frame 2 and input frame 3 as indicated by the dotted-line frame. Furthermore, suppose that the intended interpolation area Ar is decided on the interpolation frame by the interpolation area decider 22 as shown in FIG. 9.

Also in the example shown in FIG. 9, the motion vector is obtained between the frames immediately previous to the interpolation frame and between the frames that are adjacent to the interpolation frame and sandwich the interpolation frame. Specifically, as shown in FIG. 9, the motion vector is obtained between input frame 1 and input frame 2, and the motion vector is obtained between input frame 2 and input frame 3.

However, in this example, each one group of plural candidates for the motion vector is obtained between input frame 1 and input frame 2 and between input frame 2 and input frame 3.

Specifically, as shown in FIG. 9, for input frame 1, the motion vector is obtained about an image area Ar(11) at the same position as that of the interpolation area Ar set on the interpolation frame, similarly to the above-described embodiment. In addition, as shown in FIG. 9, the motion vectors about image areas Ar(12) to Ar(19) around the image area Ar(11) are also obtained.

Consequently, between input frame 1 and input frame 2, a motion vector candidate group (motion vector collection) composed of nine motion vectors MV11 to MV19 about the image areas Ar(11) to Ar(19) as the motion vector candidates is formed.

Similarly, for input frame 2, the motion vector is obtained about an image area Ar(21) at the same position as that of the interpolation area Ar set on the interpolation frame, similarly to the above-described embodiment. In addition, as shown in FIG. 9, the motion vectors about image areas Ar(22) to Ar(29) around the image area Ar(21) are also obtained.

Consequently, between input frame 2 and input frame 3, a motion vector candidate group (motion vector collection) composed of nine motion vectors MV21 to MV29 about the image areas Ar(21) to Ar(29) as the motion vector candidates is formed.

Subsequently, similarly to the above-described embodiment, each of these 18 motion vectors MV11 to MV19 and MV21 to MV29 is applied between input frame 2 and input frame 3 sandwiching the interpolation frame.

Thereafter, about each of the motion vectors, the value of correlation between the image area on input frame 2 and the image area on input frame 3 associated with each other by the motion vector is obtained. Subsequently, the motion vector of the highest correlation (smallest correlation value) is selected as the motion vector used in the interpolation processing.

As above, plural motion vectors can be obtained between each of plural pairs of frames dependent on the position of the interpolation frame, and the optimum motion vector can be selected from the obtained motion vectors. By using a larger number of motion vectors in this manner, the more proper motion vector can be selected.

If the number of motion vectors is increased, the processing burden also becomes larger correspondingly. Therefore, depending on the performance of the frame interpolator 2 and so on, plural motion vectors may be obtained between either one of the pairs of frames as also described above and the motion vector may be selected therefrom, of course.

Although nine motion vectors are obtained for the interpolation area in the example shown in FIG. 9, the way of the obtaining of the motion vectors is not limited thereto, but the motion vectors may be obtained about image areas at arbitrary positions. For example, in addition to the motion vector about the image area at the position corresponding to the interpolation area, the motion vectors about the right and left image areas of this image area and/or the motion vectors about the upper and lower image areas of this image area may be obtained.

Furthermore, it is also possible that the motion vector about the image area at the position corresponding to the interpolation area is not obtained but the motion vectors about image areas around the image area at the position corresponding to the interpolation area are obtained and the motion vector used in the interpolation processing is selected therefrom.

In the above-described embodiment, for each of the interpolation areas sequentially decided, the motion vector about the image area at the same position on the input frame is obtained. However, the way of the obtaining of the motion vectors is not limited thereto.

As described above with use of FIG. 9, the motion vectors about predetermined image areas around the image area at the same position as that of the decided interpolation area may be obtained between the intended input frames.

Moreover, the motion vector from the position indicated by the motion vector about the image area at the same position as that of the decided interpolation area may be included in the collection of motion vectors.

For example, in the case of the example shown in FIG. 2, FIG. 4, and FIG. 9, the first motion vector to input frame 2 about the image area at the same position on input frame 1 as that of the interpolation area is obtained. In this state, the second vector to input frame 3 about the image area indicated by the first motion vector on input frame 2 is obtained.

In this manner, the plural motion vectors that are obtained in turn in such a way that the position on the frame corresponding to the decided interpolation area serves as the base point may be included in the group of candidates for the motion vector used for the interpolation.

In this case, the motion vectors are not limited to motion vectors between input frame 1 and input frame 2 and motion vectors between input frame 2 and input frame 3. For example, motion vectors between input frame 3 and the next input frame 4 may be further obtained. That is, arbitrary positions can be employed as the frame position as the start point and the frame position as the end point.

Furthermore, the way of the obtaining of the motion vectors is not limited to that in which motion vectors between different pairs of frames are successively obtained based on one motion vector. For example, the following way is also possible of course. Specifically, as shown in FIG. 9, plural motion vectors are obtained between input frame 1 and input frame 2. Thereafter, plural motion vectors to input frame 3 from the respective image areas indicated by the obtained plural motion vectors on input frame 2 are successively obtained.

In the above-described embodiment, as described with use of FIG. 2 and FIG. 4, the motion vector group creator 23 obtains motion vectors between the frames immediately previous to the interpolation frame and between the frames that are adjacent to the interpolation frame and sandwich the interpolation frame. However, the way of the obtaining of the motion vectors is not limited thereto.

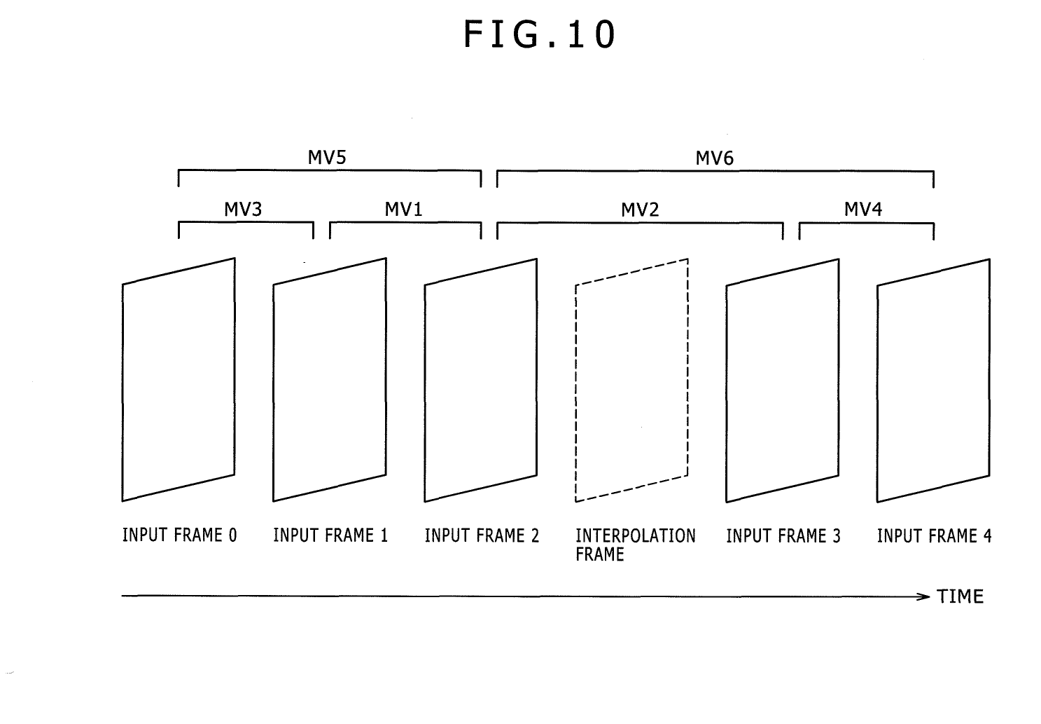

FIG. 10 is a diagram for explaining one example of the combination of frames from which the motion vector is obtained. As shown in FIG. 10, the motion vector (MV1) between the input frames immediately previous to the interpolation frame and the motion vector (MV2) between the input frames that are adjacent to the interpolation frame and sandwich the interpolation frame can be used as described above.

In addition, as shown in FIG. 10, the motion vector (MV3) obtained between input frame 0 and input frame 1, which are previous to input frame 2 immediately previous to the interpolation frame, may be used. Moreover, the motion vector (MV4) obtained between input frame 3 and input frame 4 immediately subsequent to the interpolation frame may be used.

Furthermore, as shown in FIG. 10, other motion vectors such as the motion vector (MV5) obtained between input frame 0 and input frame 2 and the motion vector (MV6) obtained between input frame 2 and input frame 4 may be used.

The candidates for the motion vector used for the interpolation can be obtained based on various kinds of correspondence in the range in which probable motion vectors can be obtained in consideration of the position of the interpolation frame and the position of the interpolation area set on the interpolation frame.

In the above-described embodiment, in the selection of one motion vector actually used for the interpolation from the group of candidates for the motion vector used for the interpolation, the motion vector is selected based on the values of correlation between the image areas associated with a respective one of the motion vectors on different frames.

However, the way of the motion vector selection is not limited thereto. For example, the value of the motion vector may be modified by, in the calculation of the correlation value, scanning an area near the image area and calculating the correlation value including this near area. That is, for example, even in the case of using the image area having the same size as that of the macroblock, a more accurate correlation value can be obtained by calculating the correlation value also in consideration of pixels around the image area.

As the correlation value, besides the above-described SAD (sum of absolute differences), any of other kinds of values capable of indicating the degree of correlation between two image areas composed of pixels can be used. For example, the sum of squared differences (SSD) or the mere sum of differences can be used.

### Modification Example 2

The frame interpolator 2 of the above-described embodiment executes, for forming an interpolation frame, interpolation processing after selecting one motion vector used in the interpolation processing from at least two motion vectors between at least one pair of frames dependent on the position of the interpolation frame.

Therefore, if the motion vector between the intended frames is calculated in advance, the frame interpolator 2 does not need to obtain the motion vector and the whole of the frame interpolation processing can be realized at lower processing cost.

Thus, in this modification example 2, for example, the motion vectors extracted by the decoder for the video stream are utilized as they are to thereby suppress the circuit scale and power consumption of the whole of the frame interpolation device.

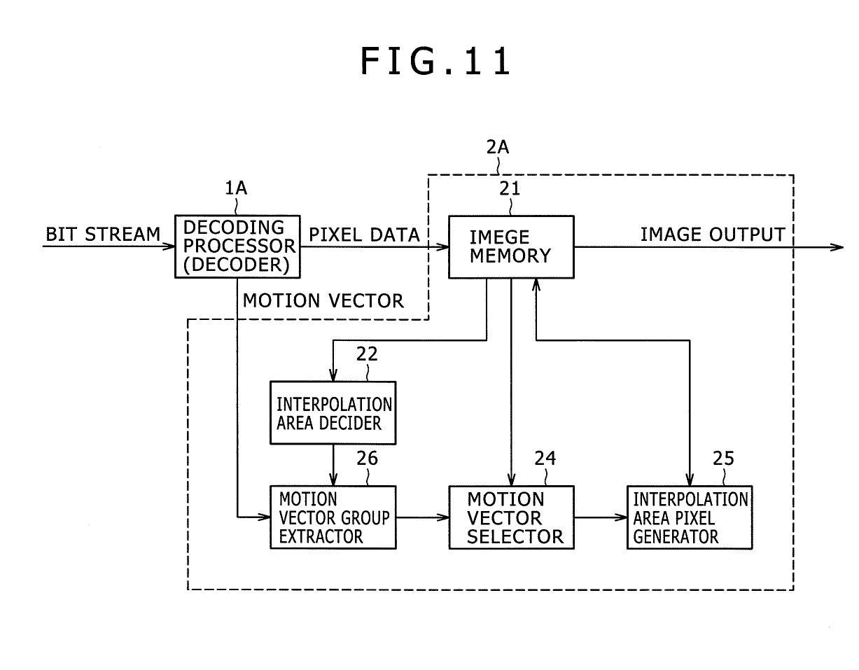

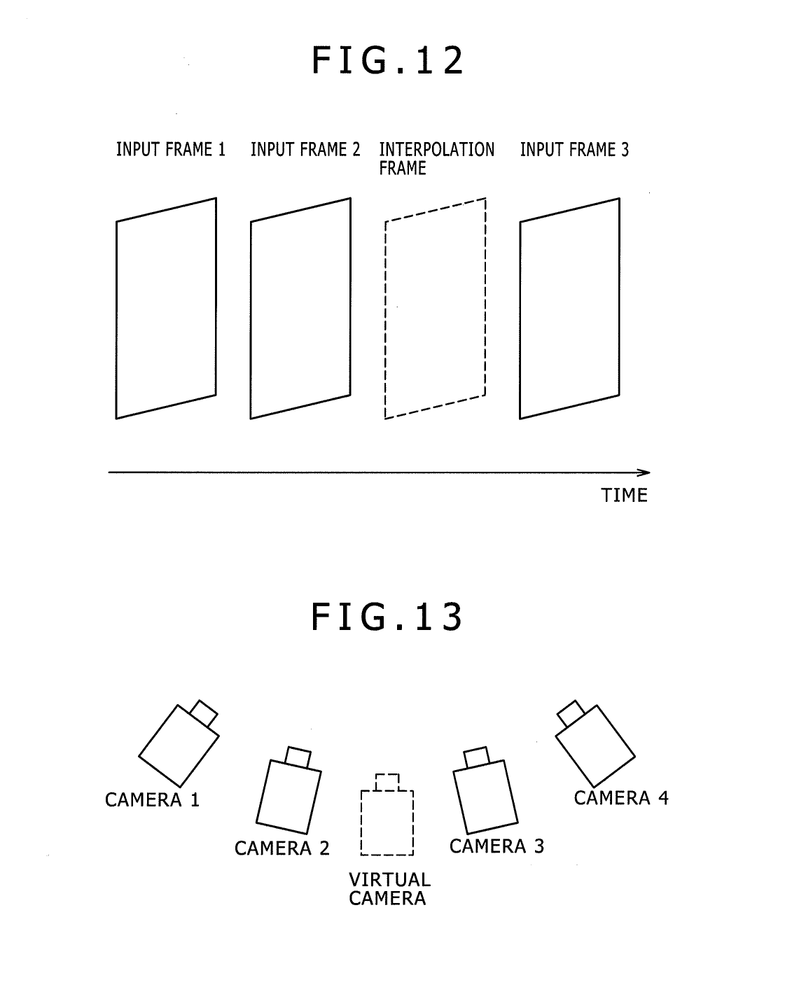

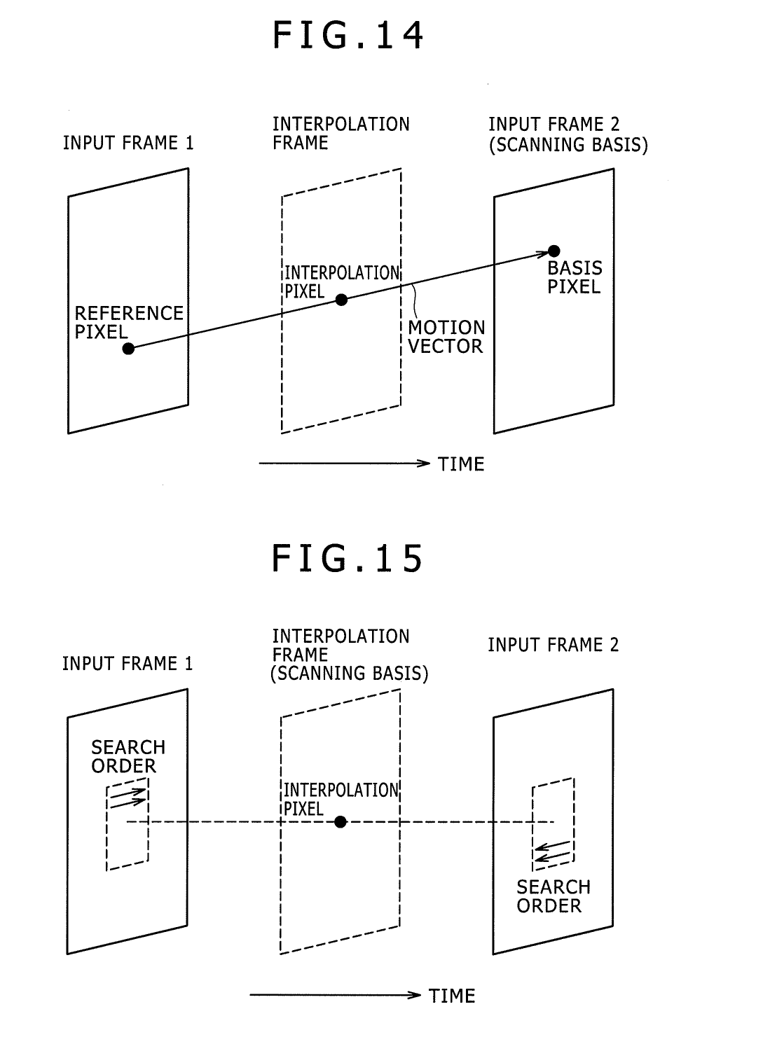

FIG. 11 is a block diagram for explaining a frame interpolator 2A in this modification example 2. In FIG. 11, the same part as that in the frame interpolator 2 shown in FIG. 1 is given the same reference numeral and the detailed description of this part is omitted to avoid the redundancy.

In FIG. 11, a decoding processor 1A has functions to execute decoding processing for moving image data arising from coding by a predetermined moving image coding system to thereby restore the original moving image data before the coding, and supply this restored moving image data (pixel data in units of the frame) to the frame interpolator 2A, similarly to the decoding processor 1 shown in FIG. 1.

Furthermore, the decoding processor 1A in this modification example 2 supplies the motion vectors extracted in the process of the decoding processing for the moving image data to a motion vector group extractor 26 in the frame interpolator 2A, which will be described in detail later.

The motion vector supplied from the decoding processor 1A to the motion vector group extractor 26 is so configured as to allow discrimination about which frame and which image area the motion vector corresponds to.

In this frame interpolator 2A of this modification example 2, the motion vector group extractor 26 is provided instead of the motion vector group creator 23 as is apparent from comparison between FIG. 1 and FIG. 11.

Also in the frame interpolator 2A of this modification example 2, the interpolation area decider 22 decides the interpolation area on the interpolation frame to be formed by the interpolation and notifies the motion vector group extractor 26 of which position on the interpolation frame the interpolation area is decided at.

As also described above, the motion vector group extractor 26 is supplied with the motion vectors extracted by the decoding processor 1A in such a manner as to be capable of discriminating which frame and which image area the motion vector corresponds to.

Thus, the motion vector group extractor 26 extracts the motion vector about the intended image area between the intended pair of frames depending on the position of the interpolation frame and the position of the interpolation area decided on the interpolation frame.

Examples of the intended pair of frames include the pair of frames immediately previous to the interpolation frame and the pair of frames that are adjacent to the interpolation frame and sandwich the interpolation frame as described with use of FIG. 2 and FIG. 4. Examples of the intended image area include the image area having a predetermined size at the same position as that of the interpolation area decided by the interpolation area decider 22 on the interpolation frame.

Therefore, in the frame interpolator 2A shown in FIG. 11, by the motion vector group extractor 26, plural motion vectors about the intended image areas between the intended pairs of frames can be extracted from the motion vectors supplied from the decoding processor 1A.

The motion vector group extractor 26 supplies the extracted motion vectors to the motion vector selector 24. The motion vector selector 24 selects one motion vector used for the interpolation and notifies the interpolation area pixel generator 25 of the selected motion vector as also described above.

The interpolation area pixel generator 25 generates the pixel data of the interpolation area as the current interpolation object by using the motion vector selected by the motion vector selector 24 and one or both of the image frames previous and subsequent to the interpolation frame to be formed by the interpolation.

In this manner, the frame interpolator 2A shown in FIG. 11 also realizes functions similar to those of the frame interpolator 2 shown in FIG. 1. Specifically, for forming an interpolation frame, the frame interpolator 2A executes interpolation processing after selecting one motion vector used in the interpolation processing from at least two motion vectors between at least one pair of frames dependent on the position of the interpolation frame.

However, in the frame interpolator 2A of modification example 2 shown in FIG. 11, there is no need to obtain the intended motion vector by scanning the scanning basis frame. The necessary motion vectors can be extracted from the motion vectors supplied from the decoding processor 1A and can be used.

Therefore, the processing for obtaining the intended motion vector does not need to be executed, and thus the frame interpolator 2A whose processing burden is low can be realized.

Although the motion vector extracted by the decoding processor 1A is used in this modification example 2, the configuration is not limited thereto. In some cases, the image processing system includes a coding processor (encoder) for coding moving image data by a predetermined moving image coding system, and the system includes a motion prediction processor for this coding processor.

In this case, it is also possible to use the motion vectors obtained by the motion prediction processor as they area in the frame interpolation processing after the decoding processing. Therefore, in the case of a device having plural functions such as the encoder functions, the decoder functions, and the frame interpolation functions, the motion prediction unit or the like can be used in common in realization of the respective functions. Thus, an advantage that the circuit scale of the entire device can be reduced can also be achieved.

### [Summarization of Configuration of Frame Interpolator of Embodiment]

The frame interpolator 2 of the above-described embodiment has the following features.

(1) In a device to which plural image frame data that can be numbered are input, the frame interpolator 2 has a function to calculate the motion vector about a predetermined space area between an input image frame (basis frame) of a certain number and an input image frame (reference frame) of another number, and a function to interpolate a predetermined image area in a non-existing frame (interpolation frame) between certain consecutive two frames by using the motion vector. The frame interpolator 2 selects the motion vector based on a predetermined space area on the interpolation frame from a collection of the motion vectors.

(2) In the above-described feature (1), the frame interpolator 2 calculates the value of correlation for each motion vector to thereby select the motion vector based on the predetermined space area on the interpolation frame.

(3) In the above-described feature (2), the frame interpolator 2 calculates the value of correlation by using the input image frames of the numbers immediately previous and immediately subsequent to the interpolation frame.

(4) In the above-described feature (3), the frame interpolator 2 calculates the value of correlation between the areas indicated by the motion vector based on the predetermined space area on the interpolation frame on the input image frames of the numbers immediately previous and immediately subsequent to the interpolation frame.

(5) In the above-described feature (4), the frame interpolator 2 can move the positions of the areas on the input image frames immediately previous and immediately subsequent to the interpolation frame and can obtain the value of correlation about the near positions. Subsequently, the frame interpolator 2 can select the motion vector indicating the areas at the positions corresponding to the highest value of correlation.

(6) In the above-described feature (1), the frame interpolator 2 can create the collection of the motion vectors by selecting at least one motion vector from a collection of motion vectors from an input image frame whose number is smaller than that of the interpolation frame and selecting at least one motion vector from a collection of motion vectors from an input image frame whose number is larger than that of the interpolation frame.

(7) In the above-described feature (1), the frame interpolator 2 can create the collection of the motion vectors by the motion vector about the area at the same position on another input image frame as that of the predetermined space area on the interpolation frame for which the motion vector is to be obtained.

Furthermore, the frame interpolator 2A in modification example 2 of the above-described embodiment can create a collection of motion vectors by utilizing the motion vectors extracted by the video decoder (decoding processor 1A).

Except that the configuration for creating a motion vector group is different, and the corresponding parts in the frame interpolator 2 shown in FIG. 1 and the frame interpolator 2A shown in FIG. 11 have the same configuration and functions.

### [Method and Program]

The processing of forming the intended interpolation frame (processing of interpolating a frame), executed in the frame interpolators 2 and 2A described with use of FIGS. 1 to 11, is processing to which the method according to the embodiment of the present invention is applied.

Furthermore, the respective functions of the interpolation area decider 22, the motion vector group creator 23, the motion vector selector 24, and the interpolation area pixel generator 25 in the frame interpolator 2 and those of the motion vector group extractor 26 in the frame interpolator 2A can be realized by a computer.

Specifically, it is also possible to form the frame interpolators 2 and 2A by e.g. a microcomputer. Therefore, it is also possible to execute the processing of forming the intended interpolation frame (processing of interpolating a frame), described with use of FIGS. 6 to 8, based on a program executed by the frame interpolator 2 formed of a microcomputer for example.

The program that is so configured as to be executable by the frame interpolator 2 formed of a computer in accordance with the flowcharts shown in FIGS. 6 to 8 in this manner is equivalent to the program according to the embodiment of the present invention.

The processing described with use of FIG. 7 and FIG. 8 is one example of the processing executed in the step S2 and the step S3 shown in FIG. 6. Thus, the processing executed in the step S2 and the step S3 differs depending on the positions and number of pairs of frames between which motion vectors are obtained and the positions and number of obtained motion vectors.

### [Others]

In the above-described embodiment, as the image area for obtaining the motion vector, an area having the same size as that of the macroblock composed of 16 pixels×16 pixels is employed for example. However, the image area is not limited thereto but an image area having an arbitrary size can be employed as long as it has such a size as to allow the motion vector to be properly obtained.

Furthermore, in obtaining of the motion vector, it is also possible to obtain the motion vector about the intended image area and the motion vector about an area having a predetermined size around the intended image area, and employ the average motion vector as the motion vector about the intended image area.

The description of the above embodiment is made by taking as an example the case in which the embodiment is applied to frame interpolation processing for a so-called moving image sequence composed of frame images formed in time-series order. However, the application target of the embodiment is not limited thereto.

For example, the embodiment of the present invention can be applied also to the case in which frame images ordered depending on the positions of cameras exist and a frame image is interpolated between these frame images as described with use of FIG. 13.

That is, the embodiment of the present invention can be applied to the case in which frame images ordered in terms of time or in terms of place (position) exist and a frame image that does not exist is formed between these frame images by interpolation processing.

The present application contains subject matter related to that disclosed in Japanese Priority Patent Application JP 2009-140672 filed in the Japan Patent Office on Jun. 12, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image frame interpolation device comprising:
decision means for deciding an interpolation area having a predetermined size for an interpolation frame to be interpolated between adjacent image frames;
acquisition means for acquiring at least two motion vectors between at least one pair of image frames dependent on a position of the interpolation frame based on a position of the interpolation area decided by the decision means;
selection means for applying the at least two motion vectors acquired by the acquisition means between two image frames sandwiching the interpolation frame, and selecting a motion vector to be used based on degrees of correlation between image areas that have a predetermined size and are associated with each other by a respective one of the motion vectors on the image frames; and
forming means for forming and interpolating pixel data of the interpolation area on the interpolation frame by using the motion vector selected by the selection means.

2. The image frame interpolation device according to claim 1, wherein
the acquisition means acquires a motion vector about an image area having the predetermined size at the same position on a reference frame at an anterior position as the position of the interpolation area on the interpolation frame between the at least one pair of image frames dependent on the position of the interpolation frame.

3. The image frame interpolation device according to claim 1, wherein
the acquisition means acquires a motion vector about each of image areas having a predetermined size around the image area at the same position on a reference frame at an anterior position as the position of the interpolation area on the interpolation frame between the at least one pair of image frames dependent on the position of the interpolation frame.

4. The image frame interpolation device according to claim 1, wherein
the acquisition means acquires at least a motion vector to an image frame at a position anterior to the interpolation frame and a motion vector to an image frame at a position posterior to the interpolation frame.

5. The image frame interpolation device according to claim 1, wherein
the acquisition means acquires a necessary motion vector from motion vectors extracted by a decoder for decoding coded image data to obtain image data in units of a frame.

6. An image frame interpolation method comprising the steps of:
deciding, by decision means, an interpolation area having a predetermined size for an interpolation frame to be interpolated between adjacent image frames;
acquiring, by acquisition means, at least two motion vectors between at least one pair of image frames dependent on a position of the interpolation frame based on a position of the interpolation area decided in the deciding step;
applying, by selection means, the at least two motion vectors acquired in the acquiring step between two image frames sandwiching the interpolation frame in such a way that the at least two motion vectors each pass through the interpolation area on the interpolation frame, and selecting, by the selection means, a motion vector to be used based on degrees of correlation between image areas that have a predetermined size and are associated with each other by a respective one of the motion vectors on the image frames; and
forming and interpolating, by forming means, pixel data of the interpolation area on the interpolation frame by using the motion vector selected in the selecting step.

7. An image frame interpolation program that is readable by a computer and causes a computer incorporated in an image processing device for processing image data to carry out the steps of:
deciding an interpolation area having a predetermined size for an interpolation frame to be interpolated between adjacent image frames;
acquiring at least two motion vectors between at least one pair of image frames dependent on a position of the interpolation frame based on a position of the interpolation area decided in the deciding step;
applying the at least two motion vectors acquired in the acquiring step between two image frames sandwiching the interpolation frame in such a way that the at least two motion vectors each pass through the interpolation area on the interpolation frame, and selecting a motion vector to be used based on degrees of correlation between image areas that have a predetermined size and are associated with each other by a respective one of the motion vectors on the image frames; and
forming and interpolating pixel data of the interpolation area on the interpolation frame by using the motion vector selected in the selecting step.

8. An image frame interpolation device comprising:
a decider configured to decide an interpolation area having a predetermined size for an interpolation frame to be interpolated between adjacent image frames;
an acquirer configured to acquire at least two motion vectors between at least one pair of image frames dependent on a position of the interpolation frame based on a position of the interpolation area decided by the decider;
a selector configured to apply the at least two motion vectors acquired by the acquirer between two image frames sandwiching the interpolation frame, and select a motion vector to be used based on degrees of correlation between image areas that have a predetermined size and are associated with each other by a respective one of the motion vectors on the image frames; and
a forming unit configured to form and interpolate pixel data of the interpolation area on the interpolation frame by using the motion vector selected by the selector.
